(19) United States
(12) Patent Application Publication
(10) Pub. No.: US 2020/0284720 A1
(43) Pub. Date: Sep. 10, 2020

(54) METHOD FOR MEASURING A CONCENTRATION OF A GAS

(71) Applicant: WILCO AG, Wohlen (CH)

(72) Inventor: Anton WERTLI, Wohlen (CH)

(73) Assignee: WILCO AG, Wohlen (CH)

(21) Appl. No.: 16/482,336

(22) PCT Filed: Jan. 30, 2018
(86) PCT No.: PCT/EP2018/052307

§ 371 Date: Jul. 31, 2019

(30) Foreign Application Priority Data
Jan. 31, 2017 (CH) 00108/17

(51) Int. Cl. G01N 21/3504; G01N 21/359

(52) U.S. Cl. CPC G01N 21/3504; G01N 2201/0634; G01N 21/359

(57) ABSTRACT

A method of measuring a concentration of a gas in the headspace of a container is provided. The headspace contains particles and/or droplets and/or the container carries on an exterior section surrounding the headspace particles and/or droplets. The container is at least in parts transparent to electromagnetic radiation. The method comprises the steps: subjecting said headspace to input electromagnetic radiation; receiving from said headspace output electromagnetic radiation in form of transmitted and/or reflected and/or diffused input electromagnetic radiation; and generating from said received electromagnetic radiation a concentration indicative result; thereby diffusing outside the container and distant from the container said input electromagnetic radiation and/or diffusing outside the container and distant from the container said output electromagnetic radiation and/or moving said headspace with respect to said input electromagnetic radiation.

The invention addressed herein relates to a method of measuring a concentration of a gas in the headspace of a container. Under further aspects, the invention relates to an apparatus for performing the method.

In several applications there are specific requirements to the composition of a gas present in the headspace of a container with sensitive contents. Such sensitive contents may e.g. be medicals or food. The relevant gas concentration in the headspace may e.g. be the concentration of oxygen in case the content of the container may be oxidized and thereby undergo a degradation. Low oxygen concentration may suppress bacterial or fungal activity, as well. The presence of an increased level of carbon dioxide in the headspace may be an indicator for biological activity in the container. E.g. for process control or quality control there is a need to determine a concentration of a gas in a container.

As an example, infrared absorption spectroscopy is a known method, which is suitable to determine the concentration of specific monitored gases in a container. This method allows to determine a concentration of a gas in a headspace of a container in a non-invasive way, i.e. without the need of entering with a part of the measuring apparatus into the container. It is only infrared radiation that passes through the walls of the container and through the gas in the headspace to be analyzed. The radiation intensity of the infrared radiation is reduced in absorption bands specific for different species of gas.

The object of the present invention is to provide a method of measuring a concentration of a gas in the headspace of a container, wherein the headspace contains particles and/or droplets. A further object of the invention is to reduce or eliminate problems of the method of measuring a concentration of a gas in the headspace of a container known in the state of the art. An even further object of the invention is to provide an apparatus for carrying out the method.

This object is achieved by a method according to claim 1. Specifically, the addressed method is a method of measuring a concentration of a gas in the headspace of a container. The headspace of the container contains particles and/or droplets and/or the container carries on an exterior section surrounding the headspace particles and/or droplets. The container is at least in parts transparent to electromagnetic radiation. The method comprises several steps, namely subjecting the headspace to input electromagnetic radiation, receiving from the headspace output electromagnetic radiation in form of transmitted and/or reflected and/or diffused input electromagnetic radiation and generating from the received electromagnetic radiation a concentration indicative result. Thereby, i.e. at the same time,

a) the input electromagnetic radiation is diffused outside the container and distant from the container and/or
b) the output electromagnetic radiation is diffused outside the container and distant from the container and/or
c) the headspace is moved with respect to the input electromagnetic radiation.

Diffusing means stochastically scattering a significant fraction of the electromagnetic radiation, e.g. more than 50% of the radiation. Closely neighboring incident beams of electromagnetic radiation thus typically have different directions after diffusing.

All three options a), b) and c) have the effect of averaging over a multiplicity of various possible radiation paths of the electromagnetic radiation traversing the headspace of the container. The headspace of the container describes the gaseous space or room above the actual solid or liquid content/filling of the container. In case of a solid content, such as a powder or a lyophilisate, the headspace may extend as well between and around the contents of the container. Thus, a headspace is only present in case the container is not filled completely. Each of the options a), b) and c) creates the just mentioned averaging effect on its own. The combination of one or more of the options enhances the averaging effect, as the averaging mechanism of the options are independent. The averaging over a multiplicity of various possible radiation paths reduces the dependency of the concentration indicative result from the individual distribution of particles and/or droplets in the headspace of a container. This way, the reproducibility of the concentration indicative result generated by the method according to the invention can be improved.

The inventors have realized that the gas concentrations determined by absorption spectroscopy vary strongly in the case of particles and/or droplets being present in the headspace of a container or in proximity of the headspace. In general, absorption spectroscopy provides reliable results as long as a well-defined path of radiation transverses the headspace of the container. If the headspace contains particles and/or droplets, there is no such well-defined path and the result of the measurement depends strongly on the individual distribution of particles and/or droplets in the headspace of the container. Particles and/or droplets located on an exterior section of the container, such as small droplets of a condensate, may have a similar effect on the path of radiation, as their occurrence, size distribution and their local concentration on the container wall may vary between different containers and over time. Particularly after temperature changes, water droplets may condensate on the outside of a container wall in a section surrounding the headspace. In addition, the particles and/or droplets themselves can absorb electromagnetic radiation and consequently falsify the concentration indicative result. Generally spoken, the particles and/or droplets that are located in the headspace of the container and/or on an exterior section of the container surrounding the headspace cause a reduction of the intensity of the output electromagnetic radiation. The container may as well have labels on its outer surface or be equipped with additional elements, such as an auto-injector, which adversely affect the measurement of a concentration of a gas. The method according to the invention alleviates these problems at least partially.

In case the input electromagnetic radiation is diffused outside the container (cf. option a)) already diffused, i.e. scattered, electromagnetic radiation impinges the headspace and therefore also the particles and/or droplets located therein. The scattered electromagnetic radiation comprises the same wavelength than the originally transmitted electromagnetic radiation but is not uniformly directed anymore but rather directed in a multitude of directions. Consequently, the electromagnetic radiation hits the container, in particular the headspace, at various spots. The received output electromagnetic radiation is therefore averaged over a multiplicity of various possible radiation paths, the radiation paths comprising e.g. various path lengths and various directions.

An averaging over the container wall or at least a part of the container wall is enabled by moving the headspace with respect to the input electromagnetic radiation (cf. option c)). Such a relative movement is comparable to averaging over several snapshots taken at various positions.

The method according to the invention is applicable to electromagnetic radiation in general. An example for such an electromagnetic radiation is infrared radiation.

In one embodiment of the method according to the invention, which may be combined with any of the embodiments still to be addressed unless in contradiction, at least one of
a) diffusing outside the container and distant from the container said input electromagnetic radiation; and
b) diffusing outside the container and distant from the container said output electromagnetic radiation;
   is performed.

Diffusing the electromagnetic radiation can be achieved by simple means, such as a diffusor plate, and is very effective for increasing the reproducibility of measurement results.

In one embodiment of the method according to the invention, which may be combined with any of the preaddressed embodiments and with any of the embodiments still to be addressed unless in contradiction, the particles and/or droplets are at least partially distributed in the headspace, in particular in form of an aerosol and/or in form of particles and/or droplets on walls of the container.

An aerosol describes fine solid particles or liquid droplets in gas, e.g. dust and mist are considered an aerosol. In case particles are located on the wall of the container, the particles might e.g. be finely distributed electrostatic particles. The droplets can e.g. origin from a high-viscous and/or oleaginous liquid that is stored in the container or can be liquid splashes on the wall.

In another embodiment of the method according to the invention, which may be combined with any of the preaddressed embodiments and any of the embodiments still to be addressed unless in contradiction, the particles are particles of a lyophilisate.

In this case, the headspace extends in between or around the particle of the lyophilisate. Due to the manufacturing method of lyophilisates, the resulting freeze-dried powder, i.e. the lyophilisate itself, may be highly electrostatic and may tend to stick to container walls. Depending on the properties of the substances undergoing lyophilisation, bubbles or splashes may form during the process of lyophilisation. In such a case randomly distributed lyophilisate may cover the walls in the region of the headspace in case the lyophilisation is performed in the same container where the gas concentration in the headspace shall take place. In any of these cases the presence of lyophilisate in the headspace may cause reflections and scattering of electromagnetic radiation passing the headspace of the container during a measurement of a gas concentration. The method according to this embodiment of the invention reduces the effect of such reflection and/or scattering due to lyophilisate present in the headspace on accuracy and/or reproducibility of the concentration indicative result. Lyophilisation is a common method to preserve perishable materials or make materials more convenient for transport. In particular, drugs, vitamins and other sensitive substances are available as lyophilisates. But especially for such sensitive substances it can be of significant importance to provide a reliable method of measuring a concentration of a gas, such as oxygen, in the headspace of the container the sensitive substance is stored in.

In another embodiment of the method according to the invention, which may be combined with any of the preaddressed embodiments and any of the embodiments still to be addressed unless in contradiction, the method comprises further the step of additionally diffusing outside the container the input and/or output electromagnetic radiation.

In case the method comprises two diffusing steps or a two-stage diffusing step, the method surprisingly provides even better results.

In another embodiment of the method according to the invention, which may be combined with any of the preaddressed embodiments and any of the embodiments still to be addressed unless in contradiction, the step of diffusing takes place on the surface and/or throughout the volume of a diffusor element.

Such a diffusor element can, for instance, be a disc or plate with a rough surface comprising several differently orientated reflection planes and/or diffraction planes. In case the diffusing takes place throughout the volume of the diffusor element, the diffusor element can be a body comprising e.g. grain boundaries, micro-fissures or gas inclusions.

In another embodiment of the method according to the invention, which may be combined with any of the preaddressed embodiments and any of the embodiments still to be addressed unless in contradiction, at least one diffusor element is an etched or sandblasted surface, in particular of an etched or sandblasted glass plate.

In another embodiment of the method according to the invention, which may be combined with any of the preaddressed embodiments and any of the embodiments still to be addressed unless in contradiction, at least one diffusor element is a plastic body, in particular a plastic foil.

An example for such a plastic foil is a matt adhesive tape.

In another embodiment of the method according to the invention, which may be combined with any of the preaddressed embodiments and any of the embodiments still to be addressed unless in contradiction, at least one diffusor element is moved, in particular rotated, during the step of diffusing.

In case a diffusor element is in motion the scattering of the electromagnetic radiation is averaged over at least a part of the surface or body of the diffusor element. A motion of the diffusor element causes also a motion of the reflection planes and/or diffraction planes and therefore causes a larger variety of radiation paths. In case the impinging electromagnetic radiation beam has only a small diameter, the reflection/diffraction and therefore the scattering takes place on/in only a small area/region of the diffusor element. Worst case this means that the beam is only reflected/diffracted on one reflection/diffraction plane and causes therefore only one radiation path. In special cases high input electromagnetic radiation power may be applied for measuring the concentration of a gas, in which cases potentially a significant fraction of the electromagnetic radiation is deposited on a small area and can cause damage on the container wall or the diffusor and/or may even locally destroy the substance in the container. Moving at least one diffusor element ensures that the just described damaging effects do not occur by providing several differing reflection/diffraction planes.

In another embodiment of the method according to the invention, which may be combined with any of the preaddressed embodiments and any of the embodiments still to be addressed unless in contradiction, the input electromagnetic radiation is a narrow-band laser radiation, in particular in the near-infrared range, further in particular in the range of 750-770 nm wavelength.

Electromagnetic radiation in the range of approximately 760 nm is in particular suitable for detecting oxygen (O₂), which has an absorption maximum close to 760 nm. A wavelength range as narrow as +/−60 pm around the absorption maximum may be sufficient to measure the absorption line of oxygen.

In another embodiment of the method according to the invention, which may be combined with any of the preaddressed embodiments and any of the embodiments still to be addressed unless in contradiction, the concentration of a gas is the concentration of e.g. oxygen (O₂), water vapor (H₂O), hydrofluoric acid (HF), ammonia gas (NH₃), acetylene (C₂H₂), carbon monoxide (CO), hydrogen sulfide (H₂S), ethylene (C₂H₄), ethane (C₂H₆), methane (CH₄), hydrochloric acid (HCl), formaldehyde (H₂CO), carbon dioxide (CO₂), ozone (O₃), chloromethane (CH₃Cl), sulfur dioxide (SO₂) or nitrogen oxides (NO, N₂O, NO₂).

The absorption maxima of the aforementioned substances lie in the wavelength range between 700 nm and 6000 nm.

Furthermore, a method of producing a gas concentration tested container with a gas in the headspace is addressed. The headspace of the container contains particles and/or droplets and/or the container carries on an exterior section surrounding the headspace particles and/or droplets, the container is at least in parts transparent to electromagnetic radiation and the gas concentration lies in a predetermined concentration range. The method comprises the steps of any of the aforementioned embodiments or combinations of embodiments of the method of measuring a concentration of a gas in the headspace of a container and further comprises the step of either accepting the container as positively tested gas concentration container if the concentration determined is in the predetermined concentration range or rejecting the container as negatively tested gas concentration container if the concentration determined is outside the predetermined concentration range.

The just described method of producing a gas concentration tested container with a gas in the headspace can be used as a means for quality control or quality management. For example, a non-invasive process control can be conducted for a filling process of containers. After the filling is completed, the testing of the gas concentration enables on the one hand the online quality control of the filling process itself. Irregularities in the gas concentration may indicate deviations from the standardized process or a malfunction of the filling system. On the other hand, a contamination with gas-producing microorganisms or the potential degradation of the filled substance by oxidization can be detected and the concerned container can be rejected. This way it is prevented that substandard products arrive on the market.

In one embodiment of the method of producing a gas concentration tested container with a gas in the headspace according to the invention, which may be combined with any of the preaddressed embodiments and any of the embodiments still to be addressed unless in contradiction, the predetermined concentration range is 0% to 21%, in particular 0% to 2.0%. This concentration range may be applied to the concentration of oxygen in the headspace.

Further in the scope of the invention lies an apparatus for performing the method of measuring a concentration of a gas in the headspace of a container according to the invention and/or the method of producing a gas concentration tested container with a gas in the headspace according to the invention.

Such an apparatus for performing one of the above mentioned methods or a combination thereof comprises a transmitter configured to direct input electromagnetic radiation towards a measuring zone, a holder configured to position the headspace of the container in the measuring zone, a receiver configured to receive output electromagnetic radiation emitted from the measuring zone, and an evaluation unit operably connected to the receiver and configured to generate a concentration indicative result based on the output electromagnetic radiation received by the receiver. At the same time a) the apparatus comprises a diffusor element that is arranged between the transmitter and the measuring zone and/or b) the apparatus comprises a diffusor element that is arranged between the measuring zone and the receiver and/or c) the holder of the apparatus is movable with respect to the transmitter.

The transmitter can e.g. be a laser, such as a diode laser, a photo diode can serve as a receiver and the holder can be a support structure, such as a plate or a grab, being optionally movable to be able to move the headspace with respect to the input electromagnetic radiation transmitted by the transmitter. The evaluation unit, for instance, can provide intensity-over-wavelength data and may comprise an analog-to-digital-converter, a microprocessor and/or a memory. The concentration indicative result can be provided by a measurand possessing a comparative value between the intensity I(λ₁) at a wavelength λ₁ at the absorption maximum of an absorption line of the respective gas (such as the absorption maximum in proximity of 760 nm in case of oxygen) and the intensity I(λ₂) at a wavelength λ₂ close to, but distant of this absorption line (such as 60 pm away from the absorption maximum in case of oxygen). In this case, the concentration indicative result may be calculated as (I(λ₂)−I(λ₁))/I(λ₂).

The measuring zone describes the area/zone in which the headspace of the container containing the gas to be measured is designated to be positioned in order to apply any one of the aforementioned methods or a combination thereof.

In one embodiment of the apparatus according to the invention, which may be combined with any of the preaddressed embodiments and any of the embodiments still to be addressed unless in contradiction, the apparatus comprises a further diffusor element.

Such an additional, second or further diffusor element can, for instance, be arranged between the transmitter and the container, i.e. in the input optical path, between the container and the receiver, i.e. in the output optical path, between the transmitter and a first diffusor element in the input optical path or between the receiver and a first diffusor element in the output optical path.

In another embodiment of the apparatus according to the invention, which may be combined with any of the preaddressed embodiments and any of the embodiments still to be addressed unless in contradiction,
a) a diffusor element is arranged between said transmitter and said measuring zone; or
b) a diffusor element is arranged between said measuring zone and said receiver.

This embodiment of the apparatus comprises at least one diffusor element.

In another embodiment of the apparatus according to the invention, which may be combined with any of the preaddressed embodiments and any of the embodiments still to be addressed unless in contradiction, at least one diffusor element diffuses electromagnetic radiation on its surface and/or throughout its volume.

Such a diffusor element can, for instance, be a disc or plate with a rough surface comprising several differently orientated reflection planes and/or diffraction planes. In case the diffusing takes place throughout the volume of the diffusor element, the diffusor element can be a body comprising e.g. grain boundaries, micro-fissures or gas inclusions.

In another embodiment of the apparatus according to the invention, which may be combined with any of the preaddressed embodiments and any of the embodiments still to be addressed unless in contradiction, at least one diffusor element is an etched or sandblasted surface, in particular of an etched or sandblasted glass plate.

In another embodiment of the apparatus according to the invention, which may be combined with any of the preaddressed embodiments and any of the embodiments still to be addressed unless in contradiction, at least one diffusor element is a plastic body, in particular a plastic foil.

An example for such a plastic foil is a matt adhesive tape.

In another embodiment of the apparatus according to the invention, which may be combined with any of the preaddressed embodiments and any of the embodiments still to be addressed unless in contradiction, at least one diffusor element is mounted movable, in particular rotatable, and drivable.

The diffusor element can be motor driven and e.g. be a disc comprising light-scattering characteristics that is mounted rotatably around its center. Instead of a rotating movement, the diffusor element can be moved up and down or from side to side. For the aforementioned movements the direction of the movement is preferably perpendicular to the direction of propagation of the transmitted electromagnetic radiation, i.e. light. Another kind of movement can be conducted by tilting the diffusor element, by shifting the diffusor element or by a combination of movements. All the mentioned kinds of movement may be performed e.g. by vibrating the diffusor element.

In another embodiment of the apparatus according to the invention, which may be combined with any of the preaddressed embodiments and any of the embodiments still to be addressed unless in contradiction, the transmitter is a laser, in particular a diode laser, even further in particular a tunable diode laser, emitting electromagnetic radiation in particular in the near-infrared range, further in particular in the range of 750-770 nm wavelength.

Electromagnetic radiation in the range of approximately 760 nm is in particular suitable for detecting oxygen (O₂), which has an absorption maximum close to 760 nm. A wavelength range as narrow as +/−60 pm around the absorption maximum may be sufficient to measure the absorption line of oxygen. Is the transmitter e.g. a laser, the laser can be a pulsed or a continuous laser. The use of a pulsed laser enables the allocation of wavelength and time and consequently the provision of a time-resolved intensity-over-wavelength dataset. The use of a tunable laser, e.g. a tunable diode laser, enables the scanning of a wavelength range larger than the bandwidth of the laser radiation and can consequently provide intensity over wavelength datasets for various wavelengths. To achieve this, the wavelength of the laser may be modulated according to a saw tooth profile. This modulation may additionally be superposed by a further modulation, e.g. with a rapid sinusoid, in order to allow lock-in amplification or higher order harmonics analysis of a signal on the receiver side.

The typical laser power for absorption spectroscopy lies between 0.6 mW and 5 mW.

The invention is further directed to an automatic headspace gas analyzer for measuring a concentration of a gas in the headspace of a container. The headspace contains particles and/or droplets and the container is at least in parts transparent to electromagnetic radiation. The automatic headspace gas analyzer comprises any one of the abovementioned apparatus according to the invention or a combination thereof and a conveyor system configured to transport the headspace of containers to and from the measuring zone.

The just described automatic headspace gas analyzer can facilitate quality control or quality management when e.g. integrated into an automatic filling facility. After a container is filled, the testing of the gas concentration can take place either by random or continuous sampling. On the one hand the quality of the filling process can be monitored, on the other hand the sorting of containers that do not fulfil the quality standard, i.e. exceed the predetermined maximum gas concentration, is made possible, thereby preventing the arrival of substandard products on the market.

The invention shall now be further exemplified with the help of figures. The figures show:

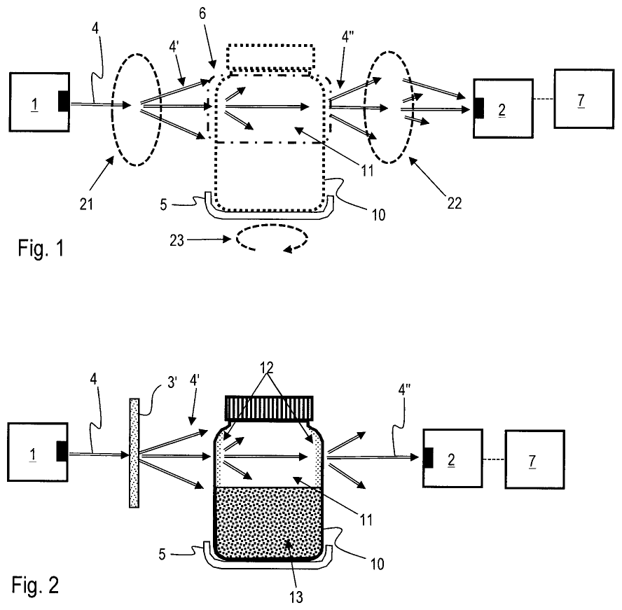

FIG. 1 a schematic view of the apparatus according to the invention for performing the method of measuring a concentration of a gas;

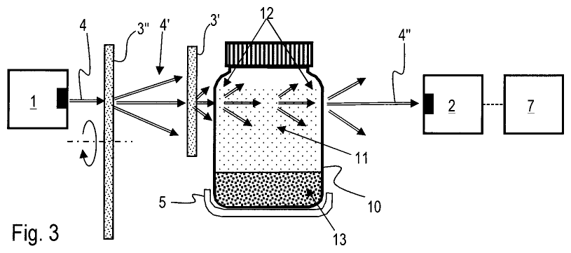

FIG. 2 a schematic view of an embodiment of the apparatus according to the invention for performing the method of measuring a concentration of a gas;

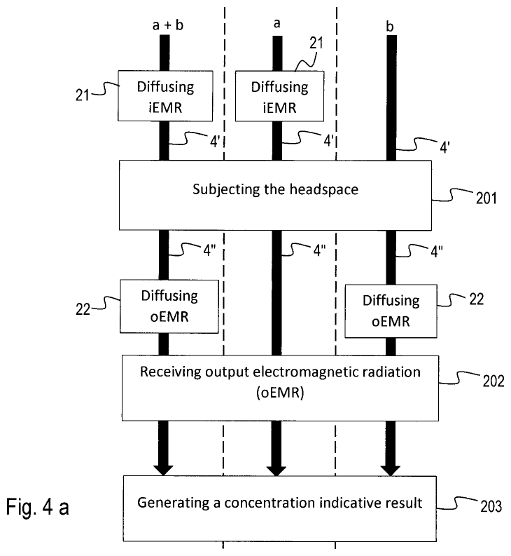

FIG. 3 a schematic view of a further embodiment of the apparatus according to the invention for performing the method of measuring a concentration of a gas;

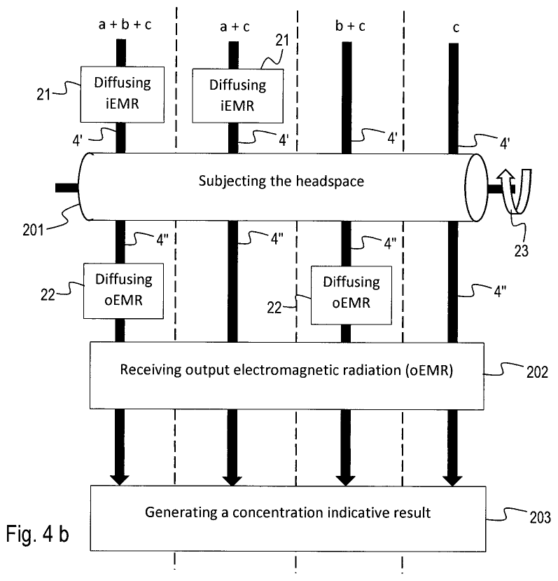

FIG. 4a a schematic drawing illustrating the method of measuring a concentration of a gas according to the invention;

FIG. 4b a further schematic drawing illustrating the method of measuring a concentration of a gas according to the invention;

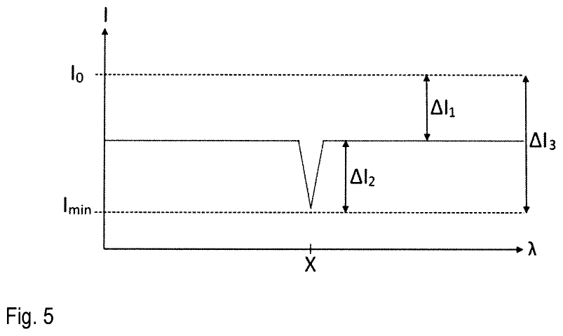

FIG. 5 an exemplary measurement from which a concentration indicative result may be derived, the measurement resulting as intermediate result in performing an embodiment of a method of measuring a concentration of a gas according to the invention;

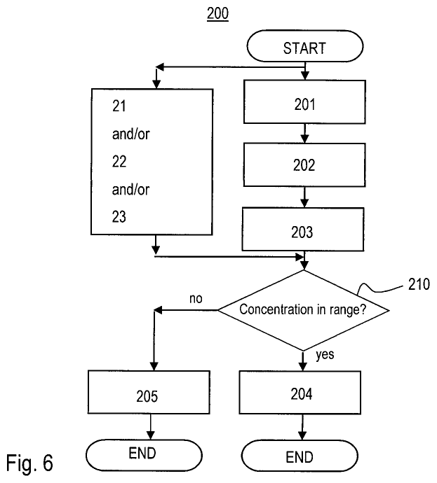

FIG. 6 a flow chart of the method according to the invention of producing a gas concentration tested container with a gas in the headspace having a gas concentration lying in a predetermined concentration range.

FIG. 1 shows schematically and simplified, an apparatus according to the invention for performing the method of measuring a concentration of a gas.

The illustrated apparatus comprises a transmitter 1 configured to transmit electromagnetic radiation 4. Furthermore, the apparatus comprises a holder 5 by which a container 10 with a headspace 11 can be positioned such that the headspace 11 is arranged inside a measuring zone 6. Moreover, the apparatus comprises a receiver 2 configured to receive output electromagnetic radiation 4″ in form of transmitted and/or reflected input electromagnetic radiation 4′ the measuring zone 6 or rather the headspace 11 is subjected to. Even further, the apparatus comprises an evaluation unit 7 configured to generate based on the electromagnetic radiation received by the receiver 2 a concentration indicative result. In addition, the apparatus comprises at least one means of averaging over a multiplicity of various possible radiation paths of the electromagnetic radiation traversing the headspace of the container. On the one hand, such a means can be configured to diffuse 21 electromagnetic radiation 4 being transmitted by the transmitter 1 and provide thereby diffuse input electromagnetic radiation 4′ the measuring zone 6 or rather the headspace 11 is subjected to. On the other hand, such a means can be configured to diffuse 22 output electromagnetic radiation 4″ in form of transmitted and/or reflected input electromagnetic radiation 4′ before the output electromagnetic radiation 4″ is received by the receiver 2. Moreover, such a means can be configured to move 23 the headspace 11 with respect to the input electromagnetic radiation 4′. The aforementioned means can be applied solely or in various combinations.

FIG. 2 shows schematically and simplified, an embodiment of an apparatus according to the invention for performing the method of measuring a concentration of a gas and a container in measuring position.

The illustrated apparatus comprises a transmitter 1 that transmits electromagnetic radiation 4. The electromagnetic radiation 4 is diffused by a diffusor element 3′ being part of the apparatus. On a holder 5, also being part of the apparatus, a container 10 is placed. The exemplary container 10 contains a content 13, such as a lyophilized pharmaceutical, but is not fully filled with the content 13 such that above the content 13 a headspace 11 is formed. Particles and/or droplets 12 of the content 13 are attached to the wall of the container 10 in the region of the headspace 11. The headspace 11 is subjected to input electromagnetic radiation being diffused by the diffusor element 3′ that is positioned between the transmitter 1 and the container 10 or rather the measuring zone where the headspace 11 is intended to be positioned. Output electromagnetic radiation 4″ in form of transmitted and/or reflected input electromagnetic radiation is received by a receiver 2 being part of the apparatus. Based on the received output electromagnetic radiation 4″ an evaluation unit 7 generates a concentration indicative result. The evaluation unit 7 is also part of the apparatus.

FIG. 3 shows schematically and simplified, a further embodiment of an apparatus according to the invention for performing the method of measuring a concentration of a gas and a container in measuring position.

This further embodiment differs from the embodiment shown in FIG. 2 both in terms of the amount and position of the diffusor element and in terms of the distribution of the particles/droplets 12 in the headspace 11. Instead of only one diffusor element, this embodiment comprises two diffusor elements 3′, 3″. The two diffusor elements 3′, 3″ are arranged in series, one 3′ after the other 3″. As a consequence, the electromagnetic radiation 4 transmitted by the transmitter 1 is diffused two-staged or in two steps. One step is performed by the first diffusor element 3″, the second step is performed by the second diffusor element 3′. Both diffusor elements 3′, 3″ are arranged outside the container 10, after the transmitter 1 and in front of the container 10, in the pathway of the electromagnetic radiation 4. As an example, which is not specific to the embodiment of the apparatus shown, the particles and/or droplets 12 are not attached to the wall of the container as shown in FIG. 2 but are finely distributed in the headspace 11 in the form of mist or dust.

FIG. 4a shows a schematic drawing that illustrates three variants of the method of measuring a concentration of a gas according to the invention. Vertical dashed lines separate the four variants marked as “a+b”, “a” and “b”.

What is common to all three variants shown are the steps of:
Subjecting 201 of the headspace to input electromagnetic radiation,
receiving 202 from the headspace output electromagnetic radiation in form of transmitted and/or reflected input electromagnetic radiation and
generating 203 from the received electromagnetic radiation a concentration indicative result.

Furthermore, on the left hand side and indicated by the letters a+b, the steps of:
diffusing 21 outside the container the input electromagnetic radiation and
diffusing 22 outside the container the output electromagnetic radiation is shown.

Additionally, in the middle and indicated by the letter a, the step of:
diffusing 21 outside the container the input electromagnetic radiation is shown.

Moreover, on the right hand side and indicated by the letter b, the step of:
diffusing 22 outside the container the output electromagnetic radiation is shown.

FIG. 4b shows a further schematic drawing that illustrates four variants the method of measuring a concentration of a gas according to the invention. Vertical dashed lines separate the four variants marked as “a+b+c”, “a+c”, “b+c” and “c”.

What is common to all four variants shown are the steps of:
subjecting 201 of the headspace to input electromagnetic radiation,
receiving 202 from the headspace output electromagnetic radiation in form of transmitted and/or reflected input electromagnetic radiation and
generating 203 from the received electromagnetic radiation a concentration indicative result.

Furthermore, on the left hand side and indicated by the letters a+b+c, the steps of:
diffusing 21 outside the container the input electromagnetic radiation,
diffusing 22 outside the container the output electromagnetic radiation and
moving 23 the headspace with respect to the input electromagnetic radiation are shown.

Additionally, in the middle left and indicated by the letters a+c, the steps of:
diffusing 21 outside the container the input electromagnetic radiation and
moving 23 the headspace with respect to the input electromagnetic radiation are shown.

Moreover, in the middle right and indicated by the letters b+c, the steps of:
diffusing 22 outside the container the output electromagnetic radiation and
moving 23 the headspace with respect to the input electromagnetic radiation are shown.

The variant shown on the right hand side and indicated by the letter c is characterized by the step of:
moving 23 the headspace with respect to the input electromagnetic radiation are shown.

FIG. 5 shows an exemplary measurement from which a concentration indicative result that can be derived, the measurement resulting as intermediate result in performing an embodiment of a method of measuring a concentration of a gas according to the invention.

The graph shows the intensity of electromagnetic radiation (y-axis) plotted against the wavelength of the electromagnetic radiation (x-axis). Furthermore, the intensity I₀ of the electromagnetic radiation transmitted by the transmitter (upper dashed line) is indicated. The continuous line shows the wavelength-dependent intensity of the output electromagnetic radiation received by the receiver. The intensity of the output electromagnetic radiation comprises a minimum Iₘᵢₙ for the wavelength X (lower dashed line). This wavelength represents the absorption maximum of the gas in the headspace of the container. Such a graph provides several comparative values ΔI₁, ΔI₂ and ΔI₃ that can be used for determining the concentration indicative result being indicative for the gas in the headspace, e.g. as function of ΔI₂ and I₀.

FIG. 6 shows a method 200 of producing a gas concentration tested container with a gas in the headspace, the headspace containing particles and/or droplets, the container being at least in parts transparent to electromagnetic radiation, the gas concentration lying in a predetermined concentration range, in particular a concentration range having its upper limit below 21%, in particular below 2.0%. The method may in particular be applied to oxygen concentration. The method comprises as first steps:
subjecting 201 the headspace to input electromagnetic radiation;
receiving 202 from the headspace output electromagnetic radiation in form of transmitted and/or reflected input electromagnetic radiation;
generating 203 from the receiving electromagnetic radiation a concentration indicative result;
thereby
a) diffusing 21 outside the container said input electromagnetic radiation and/or
b) diffusing 22 outside the container said output electromagnetic radiation and/or
c) moving 23 said headspace with respect to said input electromagnetic radiation.

Then, depending on the determined concentration the decision 210 is made whether the determined gas concentration lies in the predetermined range or not.

If the concentration is in the predetermined concentration range (arrow “yes”), the step
accepting 204 the container as positively tested gas concentration container is performed.

If the concentration is outside the predetermined concentration range (arrow “no”), then the step
rejecting 205 the container as negatively tested gas concentration container is performed.

As result, a gas concentration tested container with a gas in the headspace having a gas concentration that lies in the predetermined concentration range is produced.

### LIST OF REFERENCE SIGNS

1 transmitter
2 receiver
3 diffusor element
3′, 3″ diffusor elements
4 electromagnetic radiation
4′ input electromagnetic radiation
4″ output electromagnetic radiation
5 holder
6 measuring zone
7 evaluation unit
10 container
11 headspace
12 particles and/or droplets
13 contents
21 diffusing input electromagnetic radiation
22 diffusing output electromagnetic radiation
23 moving
200 method of producing a gas concentration tested container with a gas in the headspace
201 subjecting the headspace to input electromagnetic radiation
202 receiving from the headspace output electromagnetic radiation
203 generating a concentration indicative result
204 accepting the container as positively tested
205 rejecting the container as negatively tested
210 decision

1. A method of measuring a concentration of a gas in the headspace of a container, wherein said headspace contains particles and/or droplets and/or said container carries on an exterior section surrounding said headspace particles and/or droplets and wherein the container is at least in parts transparent to electromagnetic radiation, the method comprising the steps:
subjecting said headspace to input electromagnetic radiation;
receiving from said headspace output electromagnetic radiation in form of transmitted and/or reflected and/or diffused input electromagnetic radiation; and
generating from said received electromagnetic radiation a concentration indicative result;
thereby
a) diffusing outside the container and distant from the container said input electromagnetic radiation and/or
b) diffusing outside the container and distant from the container said output electromagnetic radiation and/or
c) moving said headspace with respect to said input electromagnetic radiation.

2. The method according to claim 1, wherein at least one of
a) diffusing outside the container and distant from the container said input electromagnetic radiation; and
b) diffusing outside the container and distant from the container said output electromagnetic radiation;
is performed.

3. The method according to claim 1, wherein said particles and/or droplets are at least partially distributed in said headspace, in form of an aerosol and/or in form of particles and/or droplets on walls of said container.

4. The method according to claim 1, wherein the particles are particles of a lyophilisate.

5. The method according to claim 2, further comprising the step of additionally diffusing outside and distant of the container the input and/or output electromagnetic radiation.

6. The method according to claim 2, wherein the step of diffusing takes place on the surface and/or throughout the volume of a diffusor element.

7. The method according to claim 6, wherein at least one diffusor element is an etched or sandblasted surface.

8. The method according to claim 6, wherein at least one diffusor element is a plastic body.

9. The claim 6, wherein at least one diffusor element is moved.

10. The claim 1, wherein said input electromagnetic radiation is a narrow-band laser radiation, in the near-infrared range.

11. The method according to claim 1, wherein said concentration of a gas is the concentration of
oxygen (O₂);
water vapor (H₂O);
hydrofluoric acid (HF);
ammonia gas (NH₃);
acetylene (C₂H₂);
carbon monoxide (CO);
hydrogen sulfide (H₂S);
ethylene (C₂H₄);
ethane (C₂H₆);
methane (CH₄);
hydrochloric acid (HCl);
formaldehyde (H₂CO);
carbon dioxide (CO₂);
ozone (O₃);
chloromethane (CH₃Cl);
sulfur dioxide (SO₂); or
nitrogen oxides (NO, N₂O, NO₂).

12. The method of producing a gas concentration tested container with a gas in the headspace, wherein said headspace contains particles and/or droplets and/or said container carries on an exterior section surrounding said headspace particles and/or droplets, wherein the container is at least in parts transparent to electromagnetic radiation, wherein the gas concentration lies in a predetermined concentration range and wherein the method comprises the steps of claim 1, and further comprises the step of either
accepting said container as positively tested gas concentration container if the concentration determined is in said predetermined concentration range; or
rejecting said container as negatively tested gas concentration container if the concentration determined is outside said predetermined concentration range.

13. The method according to claim 12, wherein the predetermined concentration range is 0%-21%.

14. An apparatus for performing the method according to claim 1, the apparatus comprising:
a transmitter configured to direct input electromagnetic radiation towards a measuring zone,
a holder configured to position said headspace of said container in said measuring zone,
a receiver configured to receive output electromagnetic radiation emitted from said measuring zone, and
an evaluation unit operably connected to said receiver and configured to generate a concentration indicative result based on the output electromagnetic radiation received by said receiver,
wherein
a diffusor element is arranged between said transmitter and said measuring zone; and/or
a diffusor element is arranged between said measuring zone and said receiver; and/or
said holder is movable with respect to said transmitter.

15. The apparatus according to claim 14, wherein
a diffusor element is arranged between said transmitter and said measuring zone; or
a diffusor element is arranged between said measuring zone and said receiver.

16. The apparatus according to claim 15, comprising a further diffusor element.

17. The apparatus according to claim 15, wherein at least one diffusor element diffuses electromagnetic radiation on its surface and/or throughout its volume.

18. The apparatus according to claim 15, wherein at least one diffusor element is an etched or sandblasted surface.

19. The apparatus according to claim 15, wherein at least one diffusor element is a plastic body.

20. The apparatus according to claim 15, wherein at least one diffusor element is mounted movable.

21. The apparatus according to claim 14, wherein said transmitter is a laser, emitting electromagnetic radiation in the near-infrared range.

22. An automatic headspace gas analyzer for measuring a concentration of a gas in the headspace of a container, wherein said headspace contains particles and/or droplets and wherein the container is at least in parts transparent to electromagnetic radiation, the automatic headspace gas analyzer comprising:
an apparatus according to claim 14,
a conveyor system configured to transport the headspace of containers to and from said measuring zone.
